(19) United States
(12) Patent Application Publication
(10) Pub. No.: US 2007/0174164 A1
(43) Pub. Date: Jul. 26, 2007

(54) Network/Processor Fraud Scoring for Card Not Present Transactions

(75) Inventors: Janet L. Biffle, Cave Creek, AZ (US); Glade R. Erikson, Glendale, AZ (US); Diane Farrell, Phoenix, AZ (US); Chin H. Khor, Glendale, AZ (US); David Joseph Knaut, Willowbrook, IL (US); Vernon Marshall, Montclair, NJ (US); John M. Rojewski, Glendale, AZ (US); Sandeep Sacheti, Edison, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/614,784

(22) Filed: Dec. 21, 2006

Related U.S. Application Data
(63) Continuation-in-part of application No. 10/162,282, filed on Jun. 3, 2002.
(60) Provisional application No. 60/295,295, filed on Jun. 1, 2001.

(51) Int. Cl. G06Q 40/00

(52) U.S. Cl. 705/35

(57) ABSTRACT

A system, method, and computer program for providing a merchant with a fraud score for a card not present transaction. A card not present transaction is detected. A fraud score is appended to a message that provides information about the card not present transaction. The message is transmitted to the merchant. In one example, the message is an authorization message. In another example the message is an address verification message.

### CROSS REFERENCE TO RELATED APPLICATIONS

This application is a continuation-in-part of U.S. patent application Ser. No. 10/162,282, entitled “System and Method for Global Automated Address Verification,” filed Jun. 3, 2002, which claims the benefit of U.S. Provisional Patent Application Ser. No. 60/295,295, entitled “Global Automated Address Verification System and Method,” filed Jun. 1, 2001; the entire contents of the '282 and '295 applications are herein incorporated by reference.

### BACKGROUND OF THE INVENTION

1. Field of the Invention

The present invention relates generally to reducing transaction account fraud. More particularly, the present invention relates to mitigating transaction account fraud during a transaction in which a card is not presented by providing a merchant with information about a risk of fraud for the transaction.

2. Background

A “card not present” (CNP) transaction is a financial transaction that does not involve presentation of a tangible card. A card not present transaction poses a higher risk of fraud than a transaction in which the card is presented because fraud-minimizing information is not readily available to a merchant. For example, an unauthorized user may complete a remote purchase by presenting only a transaction account number to the merchant. A remote purchase may be a purchase of goods that are shipped from a remote location. A remote purchase is often conducted via an electronic medium, such as a telephone or the Internet, where the merchant cannot use conventional techniques for avoiding transaction card fraud.

One conventional technique for preventing fraudulent card not present transactions is to verify a billing address of the transaction account holder. In currently available systems, purchasers input a billing address (or at least a postal code) when making a remote purchase. Transaction account issuers store the account holder's billing address. When transaction information is presented for authorization, the stored billing address is compared with the input billing address. If the stored billing address and the input billing address do not correlate, then the purchaser may be deemed to be an unauthorized user and the transaction may be denied. When the transaction account issuer denies approval, the merchant has no other information upon which to base the merchant's choice as to whether to continue the transaction with the merchant bearing the risk of fraud. This discourages not only fraudulent transactions but also valid transactions, such as a valid transaction where the input billing address is incorrectly entered.

Furthermore, often the transaction account issuer bears a burden for the fraudulent use of a transaction account, so long as purchased goods are shipped only to a stored billing address. However, if the merchant agrees to ship goods to an address other than the stored billing address, the transaction account issuer typically refuses to bear the risk of fraud. Thus, the merchant is responsible if fraud occurs. As a result, many merchants refuse to ship goods to addresses other than the stored billing address. This discourages not only fraudulent transactions but also valid transactions because it limits account holder shipping alternatives. For example, a card-holder might not be able to use the transaction card to place an order via telephone for purchase of a gift to be delivered to a non-billing address.

### BRIEF SUMMARY OF THE INVENTION

The present invention provides a system, a method, and a computer program for providing a merchant with a fraud score for a card not present transaction. A card not present transaction is detected. A fraud score is appended to a message that provides information about the card not present transaction. The message is transmitted to the merchant.

### BRIEF DESCRIPTION OF THE DRAWINGS/FIGURES

The accompanying drawings, which are incorporated herein and form a part of the specification, illustrate the invention and, together with the description, further serve to explain the principles of the invention and to enable a person skilled in the pertinent art to make and use the invention:

FIG. 1 is a block diagram of a system for address verification;

FIG. 2 is a flowchart of a method for address verification;

FIG. 3 is a flowchart of a method for providing a merchant with a fraud score in an authorization message;

FIG. 4 is a flowchart of a method for providing the merchant with the fraud score in an address verification message;

FIG. 5 is a flowchart of a method for providing a merchant with information to mitigate transaction account fraud;

FIG. 6A is a flowchart of another method for providing a merchant with the fraud score in an authorization message;

FIG. 6B is a flowchart of another method for providing a merchant with the fraud score in an address verification message; and

FIG. 7 is a block diagram of a computer system that is useful for implementing the present invention.

The invention will be described with reference to the accompanying drawings. The drawing in which an element first appears is typically indicated by the leftmost digit(s) in the corresponding reference number.

### DETAILED DESCRIPTION OF THE INVENTION

The disclosure herein presents and describes various exemplary embodiments in sufficient detail to enable those skilled in the art to practice the invention. It should be understood that other embodiments may be realized without departing from the spirit and scope of the invention. Thus, the following detailed description is presented for purposes of illustration only, and not of limitation, and the scope of the invention is defined solely by the claims.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The term “merchant” may include any person, entity, machine, software, hardware, or the like that offers a product or service to a purchaser. A merchant may offer, sell, lease, or otherwise provide a product or a service to a purchaser.

The terms “purchaser,” “customer,” “consumer,” “cardmember,” and “card-holder” are used interchangeably, and each may include any person, entity, business, or the like which engages in a commercial transaction with a merchant in accordance with various embodiments of the system. A card-holder may be an authorized or an unauthorized user of a transaction account.

The terms “user,” “end user,” “consumer,” “customer,” “participant,” and the plural form of these terms are used interchangeably throughout herein to refer to those persons or entities capable of accessing, using, being affected by, or benefiting from the present invention.

A “verification system” may include any person, entity, machine, hardware, software, business, or the like which is capable of verifying at least one of a billing address, an alternate address, and customer authentication information offered to a merchant. An alternate address is an address other that the billing address. The scope of verification may vary. Verification may include verifying at least a portion of the alternate address, the billing address, or other information associated with the card-holder. Verification may occur during the transaction, close in time, or at a time other than during the transaction, simultaneous with another process, or the like.

The term “billing address” includes an address that is associated with a card-holder and designates a location where the card-holder receives correspondence relating to a customer account. The billing address may be an address to which the card issuer sends correspondence to the card-holder regarding transaction activity in the card-holder's account. The billing address may include a first and last name, a postal address, a country, a phone number, or the like.

An “alternate address” includes an address other than the billing address. The alternate address may be a location to which a merchant is instructed to ship a purchased item. The alternate address may be a shipping address. The alternate address may be associated with a recipient who is not the card-holder and therefore may be different than the billing address.

A system, method, and computer program in accordance with various aspects of the present invention verifies customer authentication information such as a billing address or an alternate address for transaction card account purchases. A system, method, and computer program in accordance with various aspects of the present invention provides a merchant with information to mitigate transaction account fraud.

A “transaction card issuer,” “transaction account issuer,” “card issuer,” or “host” may be used interchangeably to represent any transaction account-issuing institution, such as, but not limited to, a credit card company, a card-sponsoring company, or a third party who is under contract with a financial institution. A “transaction card issuer,” “transaction account issuer,” “card issuer,” or “host” may be used interchangeably to represent any institution that provides credit, such as, but not limited to, a credit card company, a card-sponsoring company, or a third party who is under contract with a financial institution.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account, or the like. Furthermore, a physical embodiment of a transaction account may be a financial instrument, such as a transaction card. A transaction account may exist in the absence of a transaction card.

“Open cards” are financial transaction cards that are generally accepted at different merchants. Open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer.

With regard to use of a transaction account, a user may communicate with a merchant in person (e.g., at the box office), telephonically, or electronically (e.g., from a user computer via the Internet). The merchant may offer the user an option of paying for goods or services using any number of transaction accounts. Furthermore, a transaction account may be used by the merchant as a form of identification of the user.

The terms “account,” “account number,” “transaction account,” and “account code” may be used interchangeably. An account number identifies a transaction account. An account includes any code or other identifier suitably configured to allow a consumer to access, interact with, or communicate with a financial transaction system. The account number may be associated with any financial transaction instrument.

A “merchant account number” includes any code or other identifier suitably configured to identify a particular merchant. A merchant account number may be used for card acceptance, account reconciliation, reporting, and the like.

A “fraud score” is information that describes an estimated risk of fraud associated with a transaction. The fraud score may be determined by a network, processor, or a third party. The fraud score may exist in a variety of formats, such as a three-digit code. The fraud score is an alphanumeric code, such as a number in the range of zero to one. The fraud score may be in a form of text. The fraud score may be selected from a spectrum of possible fraud scores. Alternatively, the fraud score may be a binary result indicating presence or absence of fraud. The fraud score need not only convey the estimated risk of fraud but may also convey the basis for the fraud score. For example, the fraud score may convey a reason as to why an estimated risk of fraud is high. The reason may be encoded in the form of a reason code. The reason code is an alphanumeric code.

In an example, the fraud score is produced at least in part from an outcome provided by a rules engine. If the transaction meets a set of criteria by which the rules engine operates, the fraud score indicates the transaction is a high risk transaction or not a high risk transaction.

An exemplary embodiment of the present invention has a merchant system for communicating authentication information with a host authorization system. The merchant system and the host authorization system may communicate authentication information including card-holder information such as an account number and an alternate address. A verification system coupled to the host authorization system provides address verification data to the host authorization system. The verification system and the host authorization system provide verification of authentication information such as a billing address or an alternate address.

In an exemplary embodiment, a merchant receives authentication information such as a card-holder billing address, an alternate address, or the like. The merchant forwards the authentication information to a host authorization system. The host authorization system sends authentication information to a verification system which verifies at least part of the authentication information. The verification system verifies the authentication information by comparing the provided authentication information with stored information that is known to be authentic. In an example, the information known to be authentic is stored in a database. After comparing, the verification system transmits results of the comparison to the host authorization system. If the authentication information matches stored information, the authentication information provided is deemed verified. If the authentication information does not match stored information known to be authentic, the authentication information provided is deemed not verified. In an example, if the authentication information does not entirely match stored information known to be authentic, the authentication information provided is deemed partially verified.

In an exemplary embodiment, the merchant obtains authentication information from the card-holder who wishes to make a purchase without presenting a transaction card. The address information is validated by a verification system. If the authentication information provided by the purchaser does not correlate with authentic stored information, the card issuer declines to bear a risk associated with the transaction. Authentication information may include a name of a recipient of the purchased item, the recipient's address (i.e., the shipping address), the recipient's phone number, the service establishment number, the card-holder's name, the account number, the card-holder's billing address, the card-holder's phone number, known information (e.g., PIN number, address), identifying information (e.g., biometrics, photograph, and the like), information possessed (e.g., card), or the like.

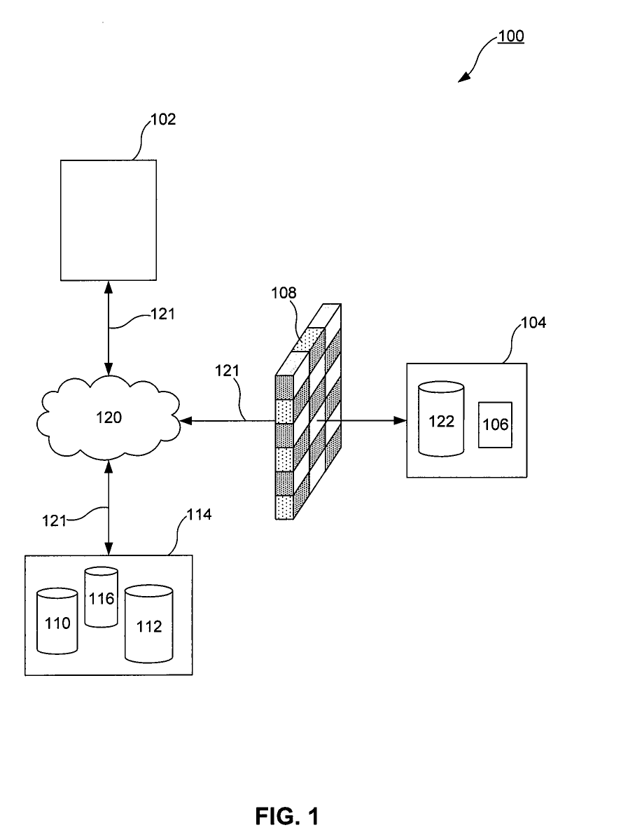

FIG. 1 is a block diagram of a system 100 for address verification. System 100 includes a merchant system 102, a host authorization system 104, and a verification system 114. Merchant system 102, host authorization system 104, and verification system 114 are configured to communicate through a network 120. Merchant system 102 submits data to host authorization system 104 via a communication channel 121. Communication channel 121 may be a part of network 120. Customer authentication information submitted to host authorization system 104 includes information associated with a card-holder. Verification system 114 is coupled to host authorization system 104 via communication channel 121 and retrieves data from host authorization system 104. System 100 verifies at least one of the customer authentication information, the alternate address, the billing address, and other information.

Network 120 is any hardware or software system for enabling communication between merchant system 102, host authorization system 104, and verification system 114. For example, network 120 may include any communications system that enables the transmission or exchange of data. Exemplary networks include the Internet, an intranet, an extranet, a wide area network (WAN), a local area network (LAN), or the like. In an exemplary embodiment, merchant system 102, host authorization system 104, and verification system 114 are coupled to network 120 by means suitable for connecting a computing system to a network. Network 120 may include a communications medium as described herein.

Merchant system 102 includes hardware or software configured to store information and interact with the other components of system 100. In an example, customer authentication information is entered into merchant system 102. Although only one merchant system 102 is illustrated in FIG. 1, it will be appreciated that system 100 may include any number of merchant systems 102 in communication with host authorization system 104 or verification system 114 through network 120. In an exemplary embodiment, host authorization system 104 and verification system 114 are separate systems, which may be located in one location or remotely located from one another. Verification system 114 may be integrated within host authorization system 104 such that an integrated verification system and host authorization system are components of a single computing device (e.g., separate modules of a single computing unit). Verification system 114 and host authorization system 104 may be separate components of an integrated computing system, wherein authorization and verification components of the computing system communicate with each other via a network.

Host authorization system 104 is configured to store information, process information and interact with the other components of system 100. Host authorization system 104 receives customer authentication information provided by merchant system 102 regarding a card purchase transaction. Host authorization system 104 processes the customer authentication information and transmits a request to verification system 114. Host authorization system 104 receives verification information from verification system 114 in response to the transmitted request. Host authorization system 104 processes verification information from verification system 114 to determine whether to permit shipment of merchandise. Host authorization system 104 communicates a payment guarantee to the merchant system 102 if the customer authentication information is verified.

Host authorization system 104 includes a host database 122 and a timing mechanism 106. Host authorization system 104 performs various authentication processes, such as billing address verification, verification of card-holder information, and credit verification. Host database 122 is configured to store card-holder data, transactional data, and any other data related to the use of a transaction card by a card-holder. Timing mechanism 106 records time. Host authorization system 104 transmits information to verification system 114 through a gateway 108. Gateway 108 may include any hardware or software for enhancing security of communications between two systems.

Verification system 114 includes a recipient database 110 and an association database 112. Verification system 114 includes hardware and software configured to store information, process information and interact with other components of system 100. Verification system 114 may include a transaction history database 116, which stores information relating to a card-holder and a card-holder's purchases that were made using a transaction card. Although illustrated in FIG. 1 as part of verification system 114, transaction history database 116 may alternatively be a part of merchant system 102, host authorization system 104, or separate.

Transaction history database 116, databases 110, 112, 122, and other data storage devices referred to herein may include any type of hardware and software device which is configured to store and maintain card-holder transaction data and any other suitable information.

Verification system 114 processes and responds to requests from host authorization system 104 for verification information regarding a designated recipient for merchandise purchased by a card-holder from the merchant. The verification information includes at least one of a recipient's name, a recipient's address, a recipient's phone number, a service establishment number, a merchant account number, a card number presented to purchase the item, a card-holder's name, a card-holder's billing address, an alternate address, a card-holder's phone number, and the like. Verification information is reliable information about a person or legal entity stored prior to a request for use of credit. By storing and processing such verification information, verification system 114 facilitates a determination by host authorization system 104 regarding whether to authorize shipment of merchandise to an address other than a billing address. Verification system 114 may be operated by a third party verification system.

In various embodiments, verification system 114 may have one or more databases, such as recipient index database 110 and association database 112. Recipient index database 110 and association database 112 have authentic information, such as address information, card-holder identity information, or the like.

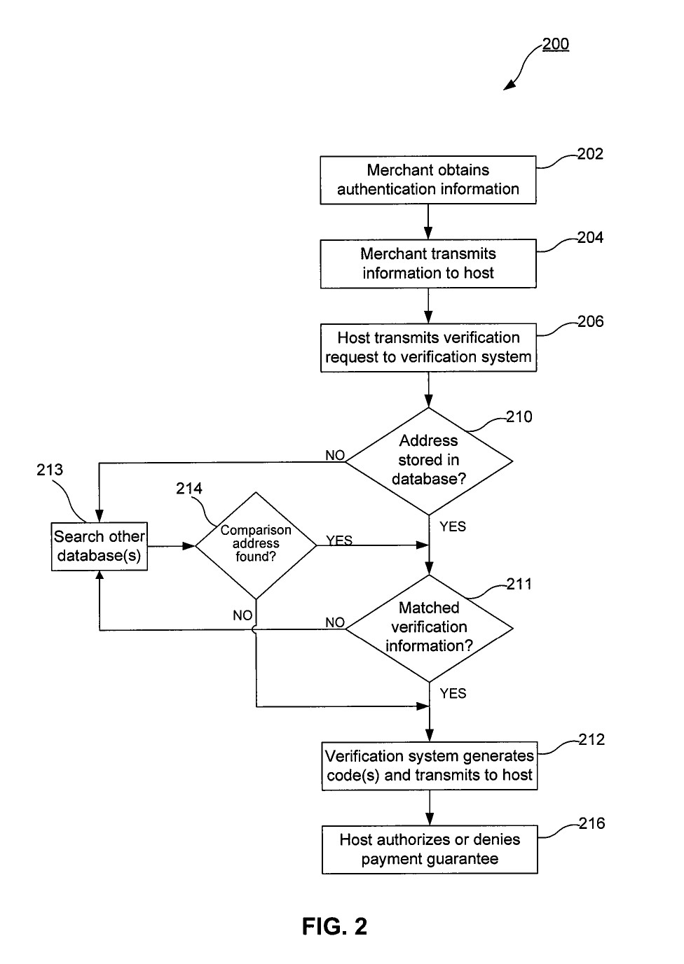

FIG. 2 is a flowchart of a method for address verification 200. The merchant obtains authentication information from a prospective transaction card purchaser (step 202). The authentication information may be obtained over the phone, via fax, via an online network (such as the Internet, for example), in-person, or by other means. Merchant system 102 is then used to transmit this information to host authorization system 104 through network 120 (step 204).

Host authorization system 104 sends at least part of the authorization information to verification system 114 (step 206). Host authorization system 104 may transmit the subset of the authorization information to verification system 114 through gateway 108. The subset of information transmitted to verification system 114 may include, for example, card number, recipient's name, recipient's address, recipient's phone number, and the service establishment number. This subset of information (i.e., “verification information”) is transmitted to verification system 114 as a “verification request.”

When verification system 114 receives a verification request, it converts the verification information into a code which may include unique tags (i.e., identifiers) that can be stored and searched. Each component of the verification information may be converted into its own unique tag. One unique tag, referred to as an “index”, may identify the alternate address, name, or other information associated with a recipient, user, or consumer. When recipient names, addresses, or the like are described herein as being stored or searched, unique tags may be used to associate the various aspects of the verification information stored or searched.

Verification system 114 queries transaction history database 116 to determine whether the address identified by the purchaser as a recipient's address is stored therein (step 210). Verification system 114 may attempt to verify the alternate address of a card-holder by comparing the alternate address to information stored in one or more databases. If the recipient's address is not stored in transaction history database 116, then verification system 114 generates a code to that effect and transmits the code to host authorization system 104. Optionally, if the recipient's address is not stored in transaction history database 116, then another database may be searched to facilitate determining the address identified by the purchaser as a recipient's address (step 213).

If the recipient address provided during a current card transaction is stored in transaction history database 116, analysis of the verification information continues. Verification system 114 searches transaction history database 116 to determine if the current verification information provided for the current card transaction matches prior verification information that was provided in a prior transaction with the same card number within a predetermined time frame (step 211). The predetermined time frame before the current transaction may be of any length. The predetermined time frame may correspond to a period of time in which it would be likely that an unauthorized user of the card number would be in the process of making multiple unauthorized card transactions.

Verification system 114 continues analyzing verification information by searching index database 110 to determine if the recipient index created by verification system 114 matches an index stored in index database 110. If no match exists, a matchcode (e.g., one or more fields of information) is generated and transmitted to host authorization system 104 (step 212). A matchcode is an alphanumeric code that identifies a level of correlation between an address to be verified and a stored address that is known to be authentic. The matchcode may include at least one selected character or digit, such as an “X” or a “9” to represent various information. Various fields of information optionally include “a” for card-holder name and billing address match, “k” for no match of information, “1” billing address match only, “p” payment guarantee, “x” system not responding, and the like. The codes and fields are optional.

If there is a match between the recipient index and an index in index database 110, then verification system 114 searches its association database 112 to determine if the recipient phone number and recipient address provided for the current transaction are associated (step 212). If so, this increases the probability that the recipient address is legitimate, and a code is transmitted to host authorization system 104 indicating that the recipient's phone number and address are associated. Verification system 114 also searches association database 112 to determine if the recipient address is a business. If so, a code is transmitted to host authorization system 104 indicating that the recipient's address is a business. Additionally, verification system 114 searches association database 112 to determine whether the current recipient's name and address match a name and address stored in association database 112. If so, the analysis continues. If not, a code is transmitted to host authorization system 104 indicating that there is no name and address match. Verification system 114 uses index database 110 to determine if the recipient name is associated with the recipient address. If so, this increases the probability that the address is legitimate, and a code is transmitted to host authorization system 104 indicating the association of the recipient's name and address. If not, then a code is returned indicating that there is no match.

If verification information provided by a card-holder matches verification information provided for a purchase made within the predetermined time frame, verification system 114 transmits the code that was originally generated for the most recent prior card transaction to host authorization system 104 (step 212). In this manner, verification system 114 identifies the card number being used in a current transaction as having been used to purchase and deliver an item to the same alternate address within the recent past. Host authorization system 104 receives and processes this code to determine whether the card issuer will authorize a payment guarantee to the merchant for the sale of an item shipped to the designated recipient. Use of the code for a current purchase that was generated for the most recent matching card number transaction efficiently indicates to the card issuer that the card has been used previously as a means for obtaining and sending purchases to an alternate address. Use of the same code for a current purchase indicates further analysis of verification information by verification system 114 is not required.

If verification information provided by a card-holder does not match any prior verification information stored in transaction history database 116, various other databases may be searched for a predetermined time period, in order to verify the recipient's address (step 213). If a comparison address is found, the step 211 is performed. If a comparison address is not found, the step 212 is performed. Verification system 114 sends tagged and coded current verification information to transaction history database 116 for storage. The verification information may be stored in transaction history database 116 for the predetermined storage period. The verification information may be compared with future transactions to determine whether a verification information match exists. A code generated during subsequent process steps using current verification information is transmitted to transaction history database 116 to be associated with the stored verification information.

Host authorization system 104 uses any or all of the transmitted codes to determine whether to offer a payment guarantee to the merchant for the current card transaction (step 216). Step 216 is optional. Host authorization system 104 may use any or all of the transmitted codes to determine whether to authorize shipment of merchandise for the current transaction. Host authorization system 104 receives and processes the code and then determines whether to authorize or deny a payment guarantee to the merchant. Host authorization system 104 may indicate that the card issuer will provide a payment guarantee if the alternate address is verified. Alternatively, host authorization system 104 may indicate that the card issuer will provide a payment guarantee if the billing address and the alternate address are verified in one transaction. Host authorization system 104 may inform the merchant system 102 of whether a payment guarantee will be granted. The merchant may authorize or deny a purchase transaction based upon whether the payment guarantee is granted. Information related to authorized or denied transactions may optionally be stored in transaction history database 116.

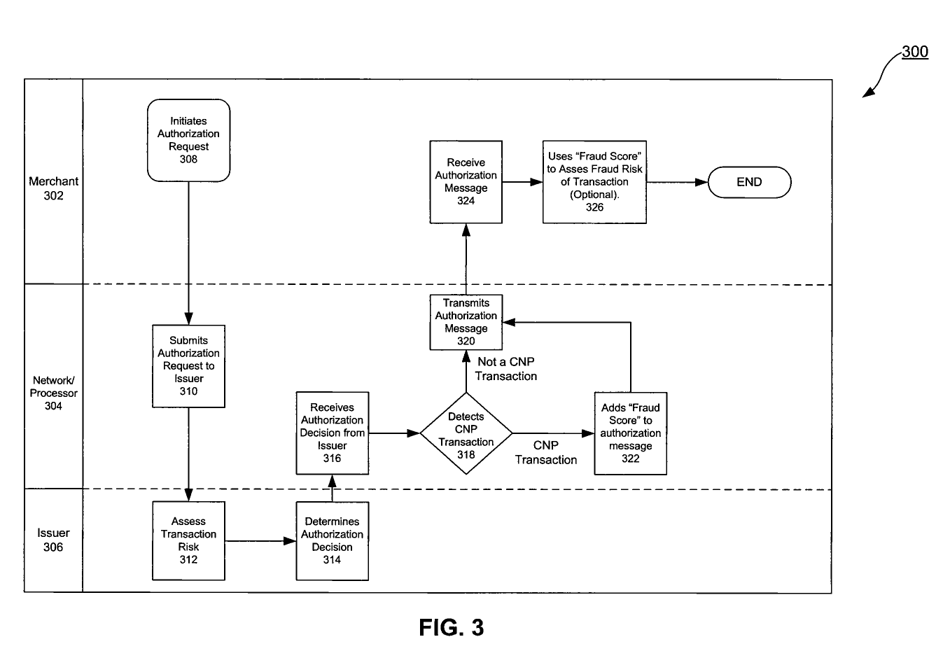

FIG. 3 is a flowchart of a method for providing a merchant 302 with a fraud score in an authorization message 300. In method 300, the fraud score is transmitted to merchant 302 in an authorization message. Merchant 302 communicates with a network/processor 304. The communication is via merchant system 102. A network/processor 304 in turn communicates with an issuer 306.

In step 308, merchant 302 initiates an authorization request. The authorization request is associated with a transaction. The authorization request includes data indicating the presence or absence of a transaction card. If a transaction card is not presented, the transaction is a “card not present” (CNP) transaction. In step 310, network/processor 304 submits the authorization request to issuer 306. In step 312, issuer 306 assesses transaction risk. Step 312 is performed at least in part by host authorization system 104. In step 314, issuer 306 determines an authorization decision. Step 314 is performed at least in part by host authorization system 104. The authorization decision is then communicated to network/processor 304. In step 316, network/processor 304 receives the authorization decision from issuer 306.

In step 318, network/processor 304 detects if the transaction is a CNP transaction. The CNP transaction is detected from the data provided by the merchant 302 in the authorization request. If the transaction is not a CNP transaction, then network/processor 304 proceeds to step 320 at which network/processor 304 transmits an authorization message. The authorization message contains the authorization decision. If the transaction is a CNP transaction, then network/processor 304 proceeds to step 322, where network/processor 304 adds a fraud score to the authorization message before proceeding to step 320. In step 324, merchant 302 receives the authorization message. In optional step 326, merchant 302 determines a risk of fraud based at least in part upon the fraud score. Network/processor 304 executes steps 310 and 316-322.

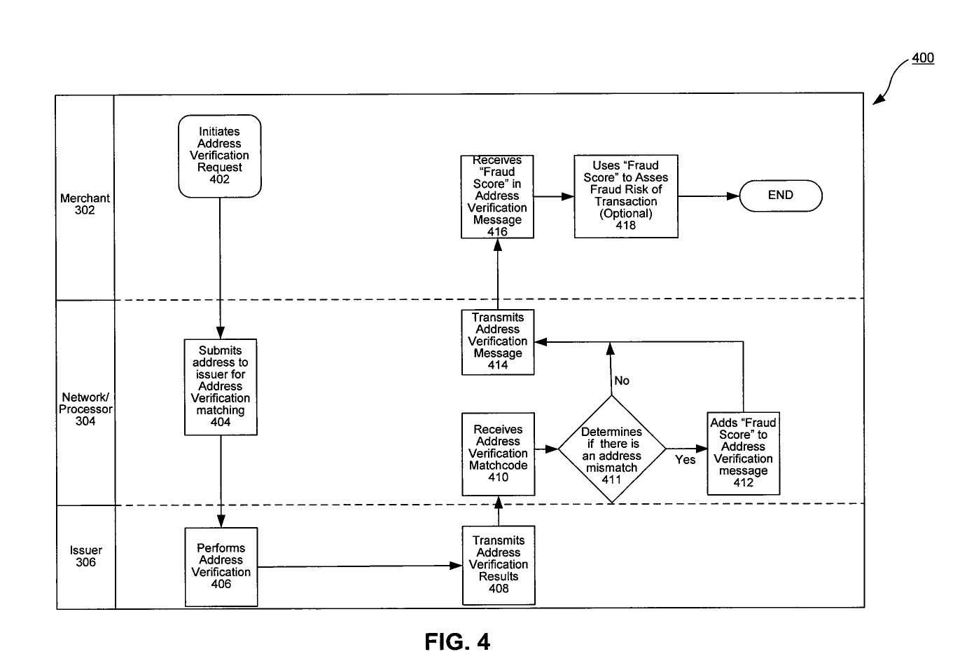

FIG. 4 is a flowchart of an exemplary method for providing merchant 302 with a fraud score in an address verification message 400. In step 402, merchant 302 requests verification of a card-holder's address by submitting the request to network/processor 304. Data submitted in the request includes the address to be verified.

In step 404, network/processor 304 forwards the card-holder's address to issuer 306 for address verification. In step 406, issuer 306 performs address verification on the card-holder's address. Issuer 306 may use at least a part of the verification system 114 to perform step 406. An example of address verification performed by issuer 306 is method for address verification 200. In step 408, issuer 306 transmits address verification results to network/processor 304. Step 408 may be performed at least in part by verification system 114.

In step 410, network/processor 304 receives the address verification results. In step 411, network/processor 304 determines if there is an address mismatch. The determination of network/processor 304 may be based at least in part on the matchcode provided by verification system 114. In step 411, if there is an address mismatch, then network/processor 304 proceeds to step 412. In step 412, network/processor 304 adds a fraud score to an address verification message and then proceeds to step 414. In step 411, if there is not an address mismatch, network/processor 304 proceeds to step 414.

In step 414, network/processor 304 transmits the address verification message. In step 416, merchant 302 receives the address verification message. In optional step 418, merchant 302 determines a risk of fraud based at least in part upon the fraud score. In an example, network/processor 304 only executes steps 410-414.

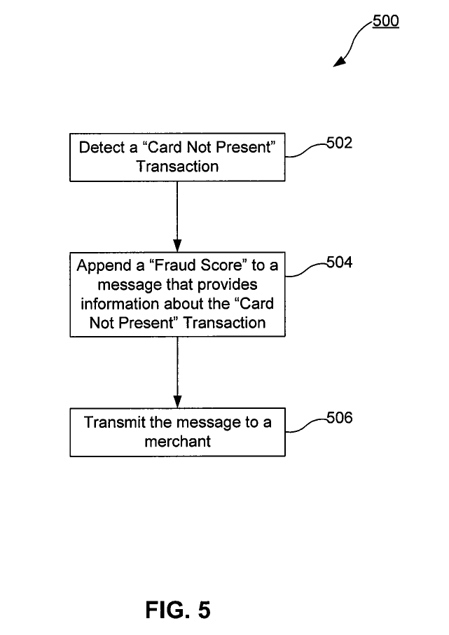

FIG. 5 is a flowchart of an exemplary method for providing merchant 302 with information to mitigate transaction fraud 500. Method 500 may be performed by network/processor 304, issuer 306, or a combination of network/processor 304 and issuer 306. In step 502, the card-not-present transaction is detected. In step 504, the fraud score is appended to a message that provides information about the card-not-present transaction. The message may be an authorization message. The message may be an authorization message that is received from an issuer 306 by network/processor 304. The authorization message may be based on an authorization decision. The message may be an address verification message. The address verification message may be based on an address verification result. In step 506, the message including the fraud score is transmitted to merchant 302. The message may be transmitted via network/processor 304. A risk of fraud of the card-not-present transaction may be determined by merchant 302 based on the fraud score.

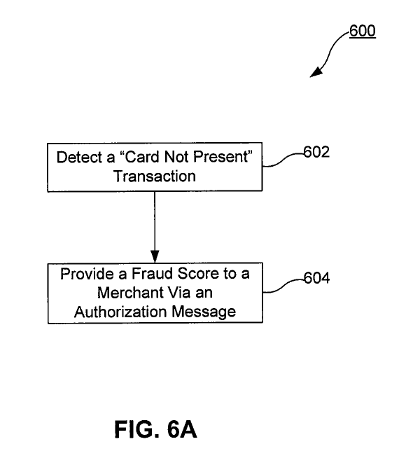

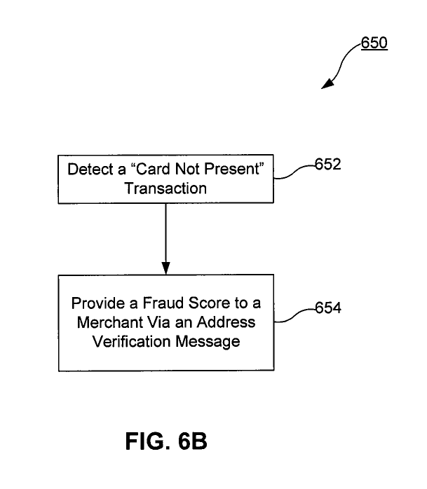

FIG. 6A is a flowchart of another method for providing merchant 302 with the fraud score in an authorization message 600. Method 600 may be performed by network/processor 304, issuer 306, or a combination of network/processor 304 and issuer 306. In step 602, the card-not-present transaction is detected. In step 604, the fraud score is provided to merchant 302 via the authorization message.

FIG. 6B is a flowchart of another method for providing merchant 302 with the fraud score in an address verification message 650. Method 650 may be performed by network/processor 304, issuer 306, or a combination of network/processor 304 and issuer 306. In step 652, the card-not-present transaction is detected. In step 654, the fraud score is provided to merchant 302 via the address verification message.

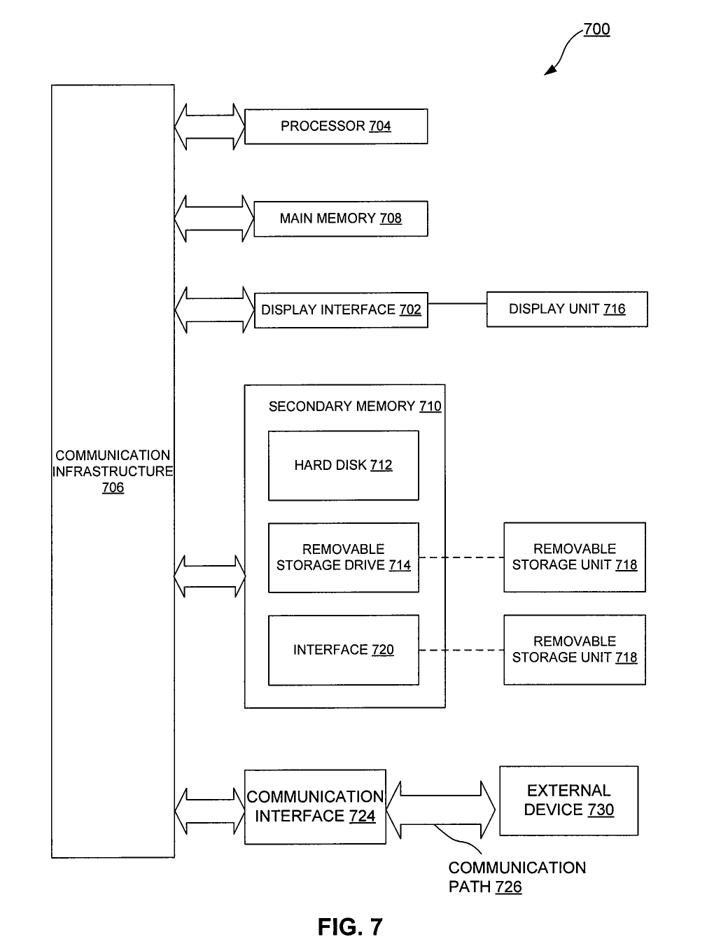

FIG. 7 is a block diagram of a computer system 700 that is useful for implementing the present invention in accordance with an exemplary embodiment of the present invention. The present invention is described herein in terms of functional block components and various processing steps. It should be appreciated that such functional blocks may be realized by any number of hardware or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. The examples described herein are illustrative of the invention and are not intended to otherwise limit the scope of the present invention in any way.

Each participant or user of the system of the present invention, including purchasers, merchants, card issuers, and third-party verifiers, for example, may be equipped with a suitable computing system to facilitate communications and transactions with any other participant. Some or all participants may have access to a computing unit in the form of a personal computer, although other types of computing units may be used, including laptops, notebooks, handheld computers, set-top boxes, kiosk terminals, personal digital assistants, cellular phones, and the like. Additionally, other participants may have computing systems in the form of a computer server, networked computers, or any other suitable implementations.

The computing systems are connected with each other via a data communications network. The data communication network may be a public network, such as the Internet. The merchant's computer system may be interconnected to a card issuer via a second network, such as a payment network. Examples of a payment network include the American Express®, VisaNet®, and Veriphone® networks.

As will be appreciated, the present invention may be embodied as a method, a data processing system, a device for data processing, or a computer program product. Furthermore, the present invention may take the form of a computer program product on a computer-readable storage medium having computer-readable program code means embodied in the storage medium. Any suitable computer-readable storage medium may be utilized, including a hard disk, a CD-ROM, an optical storage device, a magnetic storage device, or the like.

The present invention is described herein with reference to at least one block diagram and at least one flowchart of a method, an apparatus (e.g., system), and a computer program product according to various aspects of the invention. Each functional block and combinations of functional blocks in the block diagram and flowchart illustration, respectively, may be implemented by computer program instructions. These computer program instructions may be loaded onto a computer or other programmable data processing apparatus to produce a machine that implements a function described herein.

Computer program instructions may be stored in a computer-readable memory that can direct a computer or other programmable data processing apparatus to function in a particular manner, such that the instructions stored in the computer-readable memory produce an article of manufacture including instruction means which implement the function described herein. The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the function described herein.

The methods and processes herein (i.e., the system and process listed above or any part(s) or function(s) thereof) may be implemented using hardware, software, or a combination thereof. The methods and processes herein may be implemented in one or more computer systems or other processing systems. The manipulations performed by the present invention are often referred to in terms which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. In examples, host authorization system 104, merchant system 102, verification system 114, and network 120 have, or are part of, at least one computer system 700. In an example, computer system 700 performs at least a part of a method described herein.

Computer system 700 includes a processor 704. Processor 704 is connected to a communication infrastructure 706. Computer system 700 can include a display interface 702 that forwards graphics, text, and other data from communication infrastructure 706 (or from a frame buffer not shown) for display on display unit 716.

Computer system 700 also includes a main memory 708, preferably random access memory (RAM), and may also include a secondary memory 710. Secondary memory 710 may include, for example, a hard disk drive 712 or a removable storage drive 714, representing a floppy disk drive, a magnetic tape drive, an optical disk drive, an information storage device, etc. Removable storage drive 714 reads from and writes to a removable storage unit 718. Removable storage unit 718 represents a floppy disk, a magnetic tape, an optical disk, etc. which is read by, and written to, by removable storage drive 714. Removable storage unit 718 includes a computer usable storage medium having information such as a computer program or data stored therein.

In alternative embodiments, secondary memory 710 may include other similar devices for allowing computer programs or other instructions to be loaded into computer system 700. Such devices may include, for example, removable storage unit 718 and an interface 720. Examples of secondary memory 710 include a program cartridge and cartridge interface, a removable memory chip (such as an erasable programmable read only memory (EPROM), and programmable read only memory (PROM)) with an associated socket, and removable storage unit 718 or interface 720, which allow software and data to be transferred from removable storage unit 718 to computer system 700.

Computer system 700 may also include a communications interface 724. Communications interface 724 allows software and data to be transferred between computer system 700 and an external device 730. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals which may be electronic, electromagnetic, optical or other signals capable of being received by communications interface 724. These signals are provided to communications interface 724 via a communications path 726. Communications path 726 carries signals and may be implemented using a wire, fiber optics, a telephone line, a cellular link, a radio frequency (RF) link, or the like.

In this document, the terms “computer program medium” and “computer usable medium” are used to generally refer to media such as removable storage drive 714 or a hard disk installed in hard disk drive 712. Computer program products such as a computer program medium and a computer usable medium provide instructions to computer system 700. The invention is directed in part to such computer program products.

Computer programs (also referred to as computer control logic) are stored in main memory 708 or secondary memory 710. Computer programs may also be received via communications interface 724. Such computer programs, when executed, enable computer system 700 to perform the features of the present invention, as discussed herein. In particular, the computer programs, when executed, enable processor 704 to perform the features of the present invention. Accordingly, such computer programs represent controllers of computer system 700.

If the invention is implemented using software, the software may be stored in a computer program product and loaded into computer system 700 using removable storage drive 714, hard drive 712, or communications interface 724. The control logic (software), when executed by processor 704, causes processor 704 to perform the functions of the invention as described herein. In another embodiment, the invention is implemented as a hardware state machine using hardware components such as an application specific integrated circuit (ASIC).

The invention has been described with reference to exemplary embodiments. Various modifications and changes can be made without departing from the scope of the present invention as set forth in the claims. The specification and figures are to be regarded in an illustrative manner, rather than a restrictive one, and all modifications are intended to be included within the scope of present invention. Accordingly, the scope of the invention should be determined by the appended claims and their legal equivalents, rather than limited by the examples given above. For example, the steps recited in any of the method or process claims may be executed in any order and are not limited to the order presented in the claims. The Abstract and Summary sections are not intended to limit the scope of the present invention in any way.

What is claimed is:

1. A method for providing a merchant with a fraud score for a card-not-present transaction, comprising:
detecting the card-not-present transaction;
appending a fraud score to a message that provides information about the card-not-present transaction; and
transmitting said message to the merchant.

2. The method of claim 1, wherein said message is an authorization message.

3. The method of claim 1, wherein said message is an address verification message.

4. The method of claim 1, further comprising receiving an address verification result.

5. The method of claim 1, wherein said transmitting includes sending said message via a network.

6. The method of claim 1, further including determining a risk of fraud of said card-not-present transaction based on said fraud score.

7. A system for providing a merchant with a fraud score for a card-not-present transaction, comprising:
a processor; and
a memory in communication with the processor, wherein the memory stores a plurality of processing instructions for directing a processor to:
detect a card-not-present transaction;
append a fraud score to a message; and
transmit said message to a merchant.

8. The system of claim 7, wherein said message is an authorization message.

9. The system of claim 7, wherein said message is an address verification message.

10. The system of claim 7, wherein said plurality of processing instructions further includes directing said processor to receive an address verification result.

11. The system of claim 7, wherein said message is transmitted via a network.

12. A computer program product comprising a computer useable medium having control logic stored therein for causing a computer to provide a merchant with a fraud score for a card-not-present transaction, the control logic comprising:
first computer readable program code means for causing the computer to detect a card-not-present transaction;
second computer readable program code means for causing the computer to append a fraud score to a message; and
third computer readable program code means for causing the computer to transmit said message to a merchant.

13. The computer program product of claim 12, wherein said message is an authorization message.

14. The computer program product of claim 12, wherein said message is an address verification message.

15. The computer program product of claim 12, wherein said wherein said first computer readable program code means further includes a means for receiving an address verification result.

16. The computer program product of claim 12, wherein said wherein said third computer readable program code means further includes a means for sending said message via a network.
